(19) United States
(12) Patent Application Publication
(10) Pub. No.: US 2025/0190669 A1
(43) Pub. Date: Jun. 12, 2025

(54) NON-TRANSITORY COMPUTER-READABLE RECORDING MEDIUM, ESTIMATION METHOD, AND ESTIMATION DEVICE

(71) Applicant: Sumitomo Electric Industries, Ltd., Osaka (JP)

(72) Inventor: Takeshi KAWASAKI, Osaka-shi (JP)

(73) Assignee: Sumitomo Electric Industries, Ltd., Osaka (JP)

(21) Appl. No.: 18/962,273

(22) Filed: Nov. 27, 2024

(30) Foreign Application Priority Data
Dec. 7, 2023 (JP) 2023-207231

(51) Int. Cl. G06F 30/36; G06F 119/06

(52) U.S. Cl. CPC G06F 30/36; G06F 2119/06

(57) ABSTRACT

A non-transitory computer-readable recording medium having stored therein a program causes a computer to execute a process. The process includes acquiring first information related to a linear circuit having a plurality of ports for receiving or outputting a high frequency signal, and second information related to a frequency of the high frequency signal, estimating an S-parameter for two ports of the plurality of ports at the frequency, based on a learned model, and when the second information indicates that the frequency is 0 Hz and the estimated S-parameter is out of a range, restricting the S-parameter to be within the range. The learned model is generated by performing machine learning on a plurality of pieces of training data. The plurality of pieces of training data defines a relationship among a plurality of pieces of first information of the linear circuit, a plurality of frequencies, and a plurality of S-parameters.

### CROSS REFERENCE TO RELATED APPLICATIONS

This application claims priority based on Japanese Patent Application No. 2023-207231 filed on Dec. 7, 2023, and the entire contents of the Japanese Patent Application are incorporated herein by reference.

### TECHNICAL FIELD

The present invention relates to a non-transitory computer-readable recording medium, an estimation method, and an estimation device.

### BACKGROUND ART

In circuit design of a high-frequency circuit, an equivalent circuit model using a lumped constant circuit including a lumped element is used (for example, Patent Literature 1: Japanese Laid-open Patent Application Publication No. S63-61970).

### SUMMARY OF THE INVENTION

An embodiment according to the present disclosure is a non-transitory computer-readable recording medium having stored therein a program for causing a computer to execute a process. The process includes acquiring first information related to a linear circuit having a plurality of ports for receiving or outputting a high frequency signal, and second information related to a frequency of the high frequency signal, estimating an S-parameter for two ports of the plurality of ports at the frequency, based on a learned model from the first information and the second information, and when the second information indicates that the frequency is 0 Hz and the estimated S-parameter is out of a range, restricting the S-parameter to be within the range. The learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies.

The present disclosure can be implemented not only as such a characteristic non-transitory computer-readable recording medium, an estimation method, but also as an estimation device that processes such characteristic steps. Furthermore, it can be implemented as a semiconductor integrated circuit that implements part or all of the estimation device, or as an estimation system that includes the estimation device.

### BRIEF DESCRIPTION OF THE DRAWINGS

FIG. 1 is a block diagram of a linear circuit for estimating an S-parameter in a first embodiment.

FIG. 2 is a plan view of an Example 1 of the linear circuit in the first embodiment.

FIG. 3 is a plan view and a cross-sectional view of an Example 2 of the linear circuit in the first embodiment.

FIG. 4 is a block diagram of a computer in the first embodiment.

FIG. 5 is a flowchart illustrating a method of generating training data in the first embodiment.

FIG. 6 is a diagram illustrating an example of the training data in the first embodiment.

FIG. 7 is a flowchart illustrating a method of generating a learned model in the first embodiment.

FIG. 8 is a functional block diagram of an estimation device in the first embodiment.

FIG. 9 is a flowchart illustrating a method of estimating the S-parameter in the first embodiment.

FIG. 10 is a flowchart illustrating a method of estimating an S-parameter in a first comparative example.

FIG. 11 is an equivalent circuit of the linear circuit.

FIG. 12 is a diagram illustrating S21 with respect to a resistance value R of a resistor R.

FIG. 13 is a diagram illustrating S21 when ports P1 and P2 are short-circuited at direct current.

FIG. 14 is a diagram illustrating S21 when ports P1 and P2 are opened at direct current.

### DETAILED DESCRIPTION

In a high frequency band where the frequency is high, the wavelength of a high frequency signal is not sufficiently large with respect to a lumped element. Thus, when the frequency changes, the high-frequency characteristics of the high-frequency circuit may not match the equivalent circuit model using a lumped constant circuit. In addition, in the model in which the high-frequency circuit is represented by an S-parameter, it is difficult to create a model each time the configuration of the high-frequency circuit is changed. There is a method of estimating the S-parameter of the high-frequency circuit using a machine learned model, however, the accuracy of the S-parameter may be lowered.

The present disclosure has been made in view of the above problems, and an object of the present disclosure is to improve the accuracy of the S-parameter.

### Description of Embodiments of Present Disclosure

First, the contents of embodiments of the present disclosure will be listed and described.

(1) An embodiment according to the present disclosure is a non-transitory computer-readable recording medium having stored therein a program for causing a computer to execute a process. The process includes acquiring first information related to a linear circuit having a plurality of ports for receiving or outputting a high frequency signal, and second information related to a frequency of the high frequency signal, estimating an S-parameter for two ports of the plurality of ports at the frequency, based on a learned model from the first information and the second information, and when the second information indicates that the frequency is 0 Hz and the estimated S-parameter is out of a range, restricting the S-parameter to be within the range. The learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies. This can improve the accuracy of the estimation of the S-parameter.

(2) In the above (1), the restricting does not have to restrict the estimated S-parameter when the second information indicates that the frequency is other than 0 Hz. This can simplify the processing.

(3) In the above (1) or (2), when the estimated S-parameter is larger than a first maximum value of the range, the restricting may set the S-parameter to the first maximum value. When the estimated S-parameter is smaller than a first minimum value of the range, the restricting may set the S-parameter to the first minimum value. This can further improve the accuracy of the estimation of the S-parameter.

(4) In any one of the above (1) to (3), each of the plurality of S-parameters in the plurality of pieces of training data may be normalized by a second maximum value and a second minimum value. The second maximum value may be larger than a maximum value of the range. The second minimum value may be smaller than a minimum value of the range. This can further improve the accuracy of the estimation of the S-parameter.

(5) In the above (4), the estimating may estimate the S-parameter by decoding, based on the second maximum value and the second minimum value, a value generated based on the learned model. This can further improve the accuracy of the estimation of the S-parameter.

(6) In any one of (1) to (5), the restricting may restrict the S-parameter to be within the range when the two ports are opened or short-circuited. The restricting does not have to restrict the S-parameter when the two ports are not opened or short-circuited. This can further improve the accuracy of the estimation of the S-parameter.

(7) In the above (6), when the two ports are port 1 and port 2, the S-parameter may be S21. This can further improve the accuracy of the estimation of the S-parameter.

(8) An embodiment according to the present disclosure is an estimation method includes acquiring first information related to a linear circuit having a plurality of ports for receiving or outputting a high frequency signal, and second information related to a frequency of the high frequency signal, estimating an S-parameter for two ports of the plurality of ports at the frequency, based on a learned model from the first information and the second information, and when the second information indicates that the frequency is 0 Hz and the estimated S-parameter is out of a range, restricting the S-parameter to be within the range. The learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies. This can improve the accuracy of the estimation of the S-parameter.

(9) An embodiment according to the present disclosure is an estimation device includes an acquirer that acquires first information related to a linear circuit having a plurality of ports for receiving or outputting a high frequency signal, and second information related to a frequency of the high frequency signal, an estimator that estimates an S-parameter for two ports of the plurality of ports at the frequency, based on a learned model from the first information and the second information, and a restrictor that, when the second information indicates that the frequency is 0 Hz and the estimated S-parameter is out of a range, restricts the S-parameter to be within the range. The learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies. This can improve the accuracy of the estimation of the S-parameter.

### Details of Embodiments of Present Disclosure

Specific examples of a non-transitory computer-readable recording medium, an estimation method, and an estimation device according to the embodiments of the present disclosure will be described below with reference to the drawings. The present disclosure is not limited to these examples, but is defined by the scope of the claims, and is intended to include all modifications within the scope and meaning equivalent to the scope of the claims.

At least some of the embodiments described below may be combined as desired. The estimation device is configured to include a computer, and each function of the estimation device is achieved by a computer program stored in a storage device of the computer being executed by a central processing unit (CPU) of the computer. The computer program may be stored in a storage medium such as a compact disc read only memory (CD-ROM) or a digital versatile disc (DVD).

### First Embodiment

### [Linear Circuit]

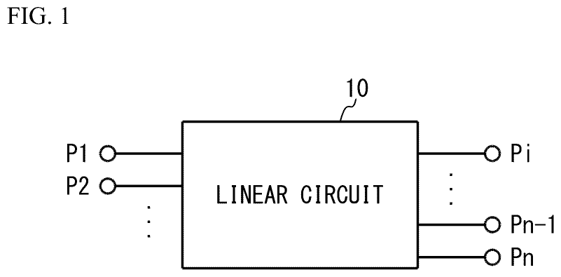

FIG. 1 is a block diagram of a linear circuit for estimating an S-parameter in a first embodiment. As illustrated in FIG. 1, a linear circuit 10 includes a plurality of ports P1, P2, . . . , Pi, . . . , Pn-1, and Pn to which a high frequency signal is received or output. Here, n is an integer corresponding to the number of ports P1 to Pn of linear circuit 10, and is 2 or more.

### Example 1 of Linear Circuit

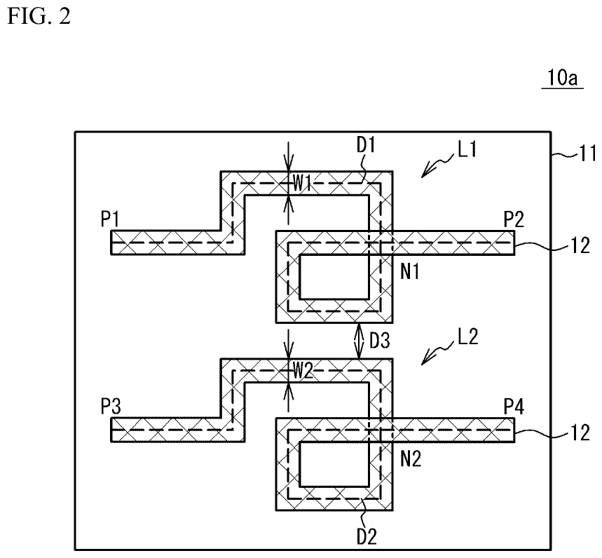

FIG. 2 is a plan view of an Example 1 of the linear circuit in the first embodiment. As illustrated in FIG. 2, in a linear circuit 10a of Example 1, a metal pattern 12 is provided on a dielectric substrate 11. Metal pattern 12 forms spiral-shaped inductors L1 and L2. Both ends of inductor L1 are denoted as ports P1 and P2, and both ends of inductor L2 are denoted as ports P3 and P4. For inductor L1, the line width is denoted as W1, the line length is denoted as D1, and the number of turns is denoted as N1. For inductor L2, the line width is denoted as W2, the line length is denoted as D2, and the number of turns is denoted as N2. The distance between inductor L1 and inductor L2 is denoted as D3.

### Example 2 of Linear Circuit

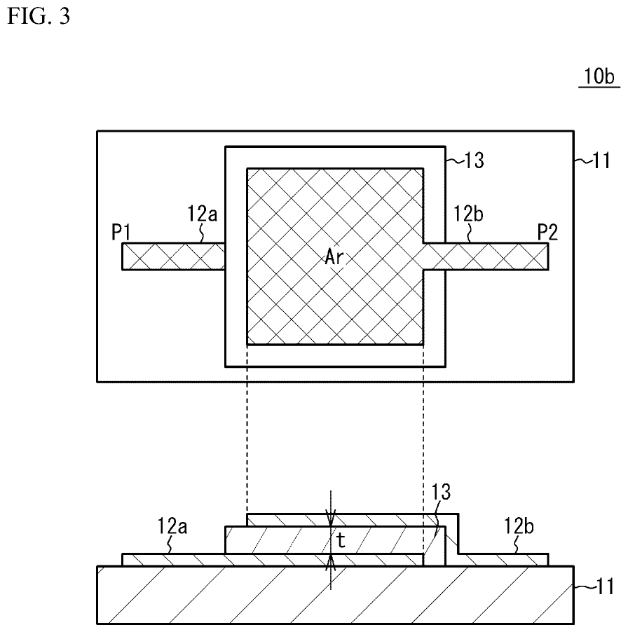

FIG. 3 is a plan view and a cross-sectional view of an Example 2 of the linear circuit in the first embodiment. As illustrated in FIG. 3, in a linear circuit 10b of Example 2, metal patterns 12a and 12b are provided on or above dielectric substrate 11. A dielectric layer 13 is provided between metal patterns 12a and 12b. Dielectric layer 13, and metal patterns 12a and 12b sandwiching dielectric layer 13 form a capacitor C. The thickness of dielectric layer 13 is denoted as t, and the area of the region where metal patterns 12a and 12b overlap with each other with dielectric layer 13 interposed therebetween is denoted as Ar. The end of metal pattern 12a and the end of metal pattern 12b are port P1 and port P2, respectively.

The information for estimating the S-parameter of linear circuit 10 is, for example, at least one of dimension information related to dimensions or physical property information related to physical properties of a material. In Example 1, the dimension information includes line widths W1 and W2, line lengths D1 and D2, numbers of turns N1 and N2, and distance D3. The physical property information includes the dielectric constant and loss tangent of dielectric substrate 11, the conductivity of metal pattern 12, and the like. In Example 2, the dimension information includes thickness t and area Ar. The physical property information includes the dielectric constant and loss tangent of dielectric layer 13, the conductivity of metal patterns 12a and 12b, and the like.

Linear circuit 10 is designed using an equivalent circuit represented by a lumped constant circuit using linear elements such as a resistor, an inductor, a capacitor, and a transmission line. Alternatively, a scattering matrix (S-parameter) for each frequency of a high frequency signal is used. In particular, the S-parameter is often used for circuit design for microwave (from 300 MHz to 30 GHz) or millimeter wave (from 30 GHz to 300 GHz) applications, for example.

### [S-Parameter]

The S-parameter (scattering matrix) of linear circuit 10 will be described. Equation 1 is a matrix of S-parameter of linear circuit 10.

$$S = ( \begin{matrix}S 11 & S 12 & … & S 1 n \\ S 21 & S 22 & … & S 2 n \\ ⋮ & ⋮ & Sk l & ⋮ \\ Sn 1 & Sn 2 & … & Snn\end{matrix} ) \qquad [ Equation 1 ]$$

The S-parameter from a port Pk to a port P1 is denoted as an element Skl. Element Skl of the S-parameter is a complex number. In a linear circuit, Skl is equal to Slk. In Example 1 in FIG. 2, n is four (n=4), and in Example 2 in FIG. 3, n is two (n=2).

### [Linear Circuit Model Using Learned Model]

It is difficult for an equivalent circuit represented by lumped constants to express high-frequency characteristics with high accuracy in a wide band. Since the S-parameter represents the high-frequency characteristics for each frequency, it is possible to express the high-frequency characteristics with high accuracy in a wide band. However, the S-parameter needs to be calculated by performing the electromagnetic field analysis for each different parameter of the linear circuit. The electromagnetic field analysis requires time and man-hours. Thus, it is difficult to design a circuit by changing the dimension information of the linear circuit.

Thus, a circuit model by a neural network is proposed in which dimension information and physical property information of a linear circuit are set as explanatory variables and the S-parameter is set as a response variable.

The estimation method of the S-parameter of the linear circuit according to the first embodiment will be described below.

### [Block Diagram of Computer]

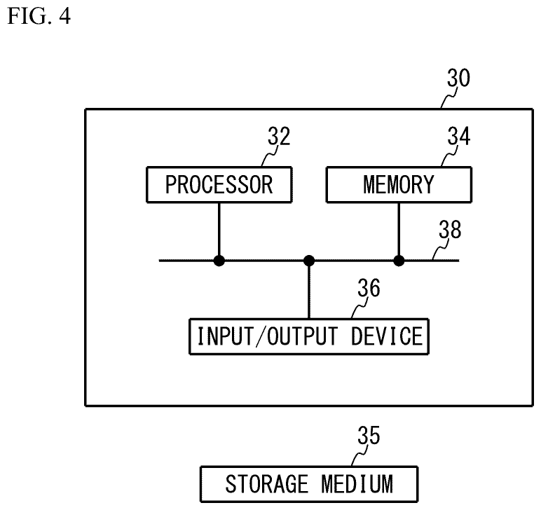

FIG. 4 is a block diagram of a computer in the first embodiment. A computer 30 functions as an estimation device that estimates the S-parameter of linear circuit 10 in cooperation with software. Computer 30 executes the estimation program to perform the estimation method.

Computer 30 includes a processor 32, a memory 34, an input/output device 36, and an internal bus 38. Processor 32 is, for example, a central processing unit (CPU), and executes a program and a method. Memory 34 is, for example, a volatile memory or a non-volatile memory, and stores data and the like used when processor 32 executes the program and the method. Memory 34 may store a program executed by processor 32. Input/output device 36 receives data to be acquired by processor 32 from an external apparatus, and outputs data output by processor 32 to the external apparatus. The external apparatus may be another computer or another program in the same computer. Internal bus 38 connects processor 32, memory 34, and input/output device 36 to each other, and transmits data and the like. The program is stored in a storage medium 35. Storage medium 35 is, for example, a non-transitory tangible medium, such as a CD-ROM or a DVD.

### [Method of Generating Training Data]

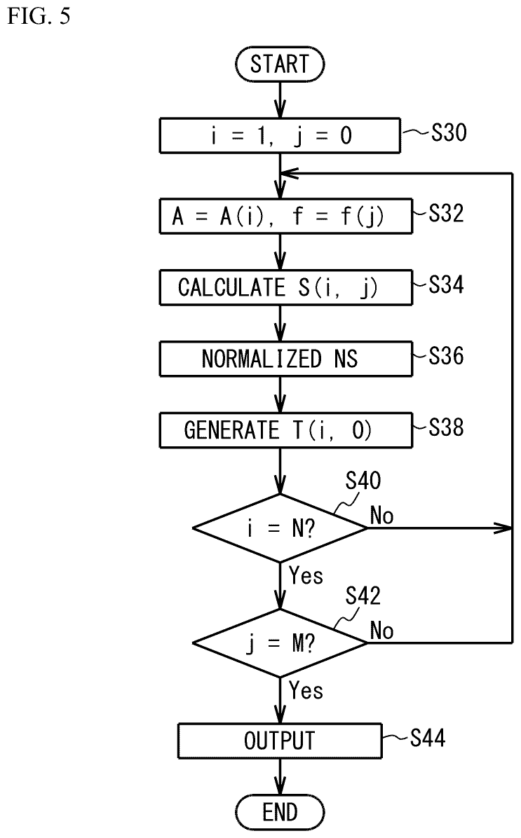

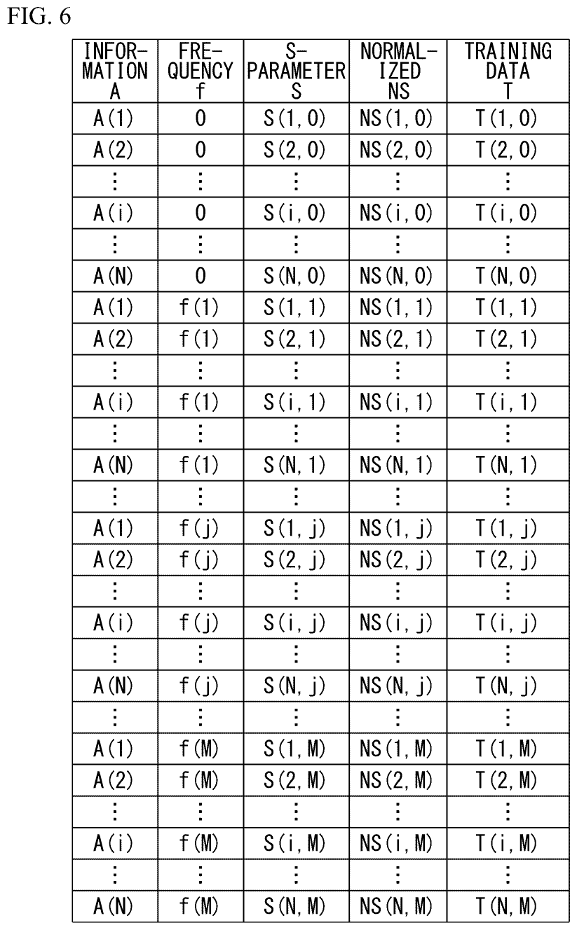

FIG. 5 is a flowchart illustrating a method of generating training data in the first embodiment. Each step in FIG. 5 may be performed by the computer illustrated in FIG. 4 or by a human. FIG. 6 is a diagram illustrating an example of the training data in the first embodiment.

As illustrated in FIG. 5, i and j are set to one and zero, respectively (step S30). Here, i is an integer from 1 to N, and j is an integer from 0 to M.

Next, information A is set to A (i), and a frequency f is set to f (j) (step S32). A (i) is, for example, dimension information and physical property information. When the material used for linear circuit 10 is fixed, the physical property information may not be used. In Example 1, dimension information includes D1 (i), D2 (i), W1 (i), W2 (i), N1 (i), N2 (i), and D3 (i). Here, i corresponds to 1 to N, and thus the value of the dimension information is varied with i. Frequency f (j) includes a frequency of 0 Hz and a frequency of other than 0 Hz. For j=0, f (0) is 0 Hz, for example.

Electromagnetic field analysis is performed based on information A (i) and frequency f (j) to calculate an S-parameter S (i, j) (step S34). Here, the matrix of the S-parameter is an n-by-n matrix as in Equation 1, and is a four-by-four matrix in Example 1 and a two-by-two matrix in Example 2. S-parameter S (i, j) is at least one element to be estimated among the elements of the matrix of Equation 1.

Calculated S-parameter S (i, j) is normalized (step S36). When S (i, j) includes a plurality of elements in the matrix of Equation 1, normalization is performed for each element. A maximum value for normalization is denoted as MAX2, and a minimum value is denoted as MIN2. When S (i, j) includes a plurality of elements, maximum value MAX2 and minimum value MIN2 may be set for each element. A normalized S-parameter NS (i, j) is equal to (S (i, j)−MIN2)/(MAX2+MIN2).

A training data T (i, 0) is generated (step S38). For example, for i=1 and j=0, training data T (1, 0) defining the relationship among information A (1), frequency f (0) of 0 Hz, and normalized S-parameter NS (1, 0) is generated as illustrated in FIG. 6.

Next, it is determined whether i is equal to N (step S40). When the result is No, the process returns to step S32. When the result is Yes, it is determined whether j is equal to M (step S42). When the result is No, the process returns to step S32.

As described above, N× (M+1) pieces of training data T (i, j) defining the relationship among information A (i), frequency f (j), and S-parameter S (i, 0) are generated.

In step S42, when the result is Yes, N×(M+1) pieces of training data T are output to memory 34 or the external apparatus (step S44). Thereafter, the process is completed.

### [Method of Generating Learned Model]

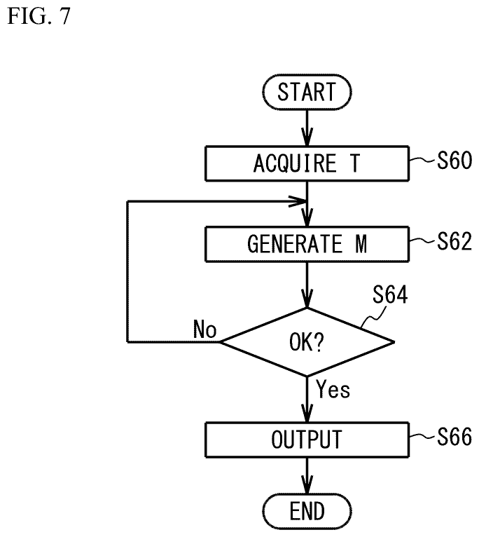

FIG. 7 is a flowchart illustrating a method of generating a learned model in the first embodiment. As illustrated in FIG. 7, processor 32 acquires N× (M+1) pieces of training data T from memory 34 or the external apparatus (step S60). Processor 32 performs machine learning based on N×(M+1) pieces of acquired training data T, and generates a learned model M (step S62). Processor 32 or a human verifies learned model M (step S64). For example, S-parameter S is estimated from information A whose relationship with the S-parameter is known, using learned model M. When the estimated S-parameter substantially matches the known S-parameter, the result is determined as Yes in step S64, and when the estimated S-parameter does not match the known S-parameter, the result is determined as No. When the result is No, the process returns to step S62.

When the result is Yes in step S64, processor 32 outputs learned model M to memory 34 or the external apparatus (step S66). Thereafter, the process is completed. Thus, learned model M is generated.

### [Estimation Method of S-Parameter]

### [Functional Block Diagram]

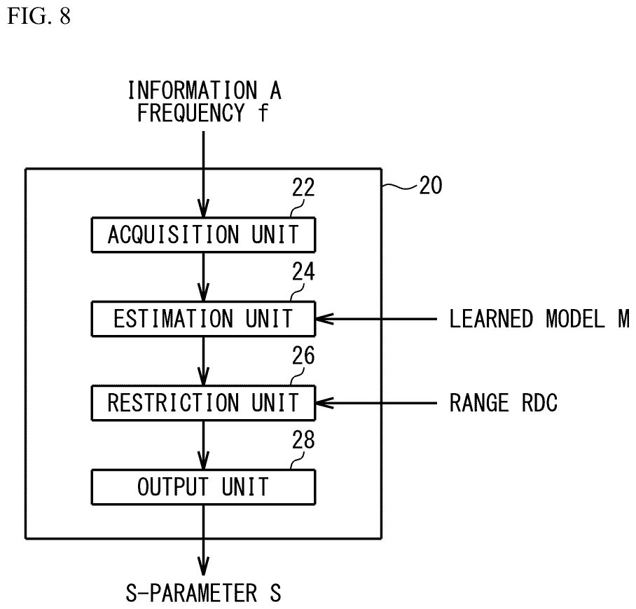

FIG. 8 is a functional block diagram of an estimation device in the first embodiment. As illustrated in FIG. 8, an estimation device 20 includes an acquisition unit 22, an estimation unit 24, a restriction unit 26, and an output unit 28. Processor 32 cooperates with software to function as acquisition unit 22, estimation unit 24, restriction unit 26, and output unit 28. Acquisition unit 22 acquires information A, frequency f, and the like of linear circuit 10 from the external apparatus via input/output device 36. Estimation unit 24 estimates S-parameter S from information A and frequency f based on learned model M. When frequency f is 0 Hz, restriction unit 26 restricts the value of the S-parameter estimated based on a range RDC. Output unit 28 outputs the S-parameter estimated by estimation unit 24 or S-parameter S restricted by restriction unit 26 to the external apparatus via input/output device 36.

### [Flowchart]

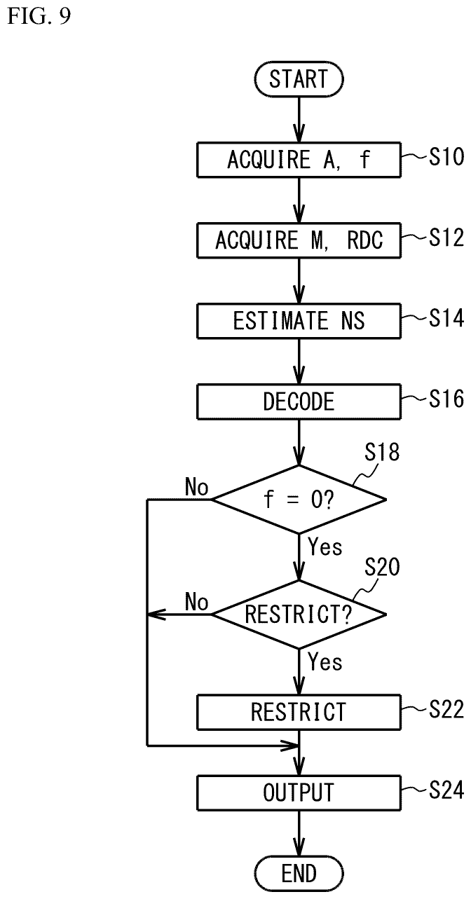

FIG. 9 is a flowchart illustrating a method of estimating the S-parameter in the first embodiment. As illustrated in FIG. 9, acquisition unit 22 acquires information A (first information) related to linear circuit 10 and information (second information) related to frequency f of the high frequency signal (step S10).

Estimation unit 24 acquires learned model M and range RDC (step S12). Estimation unit 24 may acquire maximum value MAX2 and minimum value MIN2 for normalization in addition to learned model M and range RDC. Estimation unit 24 applies learned model M to information A and frequency f, and estimate a normalized S-parameter NS (step S14).

Estimation unit 24 decodes normalized S-parameter NS (step S16). Decoded S-parameter S can be calculated by the equation of S=NS×(MAX2+MIN2)+MIN2 using normalized S-parameter NS. When normalized S-parameter NS includes a plurality of elements of the matrix, the S-parameter may be calculated for each element.

Restriction unit 26 determines whether frequency f is 0 Hz or not (step S18). When the result is No, the process proceeds to step S24. When the result is Yes, restriction unit 26 determines whether to restrict S-parameter S (step S20). For example, restriction unit 26 determines the result as Yes when two ports Pk and P1 of element Skl of the S-parameter are opened or short-circuited, and otherwise determines the result as No. Information indicating whether element Skl of the S-parameter is opened or short-circuited may be acquired from memory 34 or the external apparatus in step S12. When the result is No in step S20, the process proceeds to step S24.

When the result is Yes in step S20, restriction unit 26 restricts S-parameter S to be within range RDC. For example, when the maximum value and the minimum value of range RDC are MAX1 and MIN1, respectively, S is set to MAX (MIN1, MIN (MAX1, S)). Here, a function MAX (X, Y) is a function that outputs the larger one of X and Y. A function MIN (X, Y) is a function that outputs the smaller one of X and Y. Thus, restriction unit 26 sets S to MAX1 when S is larger than MAX1, and sets S to MIN1 when S is smaller than MIN1. The S-parameter is set to a value within range RDC.

Thereafter, output unit 28 outputs S-parameter S to memory 34 or the external apparatus (step S24). Thereafter, the process is completed.

As described above, when frequency f is 0 Hz (that is, direct current) and when ports Pk and P1 are opened or short-circuited at direct current, restriction unit 26 restricts element Skl of the S-parameter. On the other hand, when frequency f is other than 0 Hz (that is, alternating current), or when frequency f is 0 Hz and ports Pk and P1 are not opened or short-circuited at direct current, restriction unit 26 does not restrict element Skl of the S-parameter.

### First Comparative Example

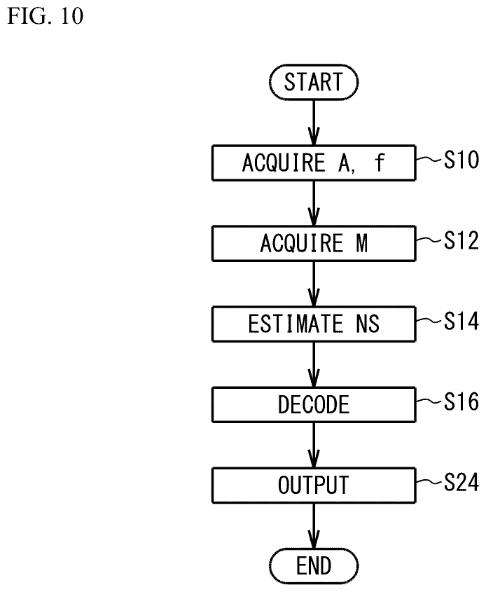

FIG. 10 is a flowchart illustrating a method of estimating an S-parameter in a first comparative example. As illustrated in FIG. 10, in the first comparative example, steps S18, S20, and S22 of FIG. 9 in the first embodiment are not provided. After step S10, processor 32 acquires learned model M regardless of frequency f (step S12). In step S12, processor 32 does not have to acquire range RDC. Processor 32 applies acquired learned model M to information A and frequency f, and estimate normalized S-parameter NS (step S14). Processor 32 decodes normalized S-parameter NS by using MAX2 and MIN2 (step S16). Thus, S-parameter S is generated. Thereafter, processor 32 outputs S-parameter S (step S24).

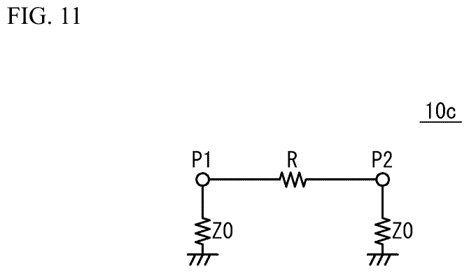

The problem of the first comparative example will be described for a linear circuit of a resistor R. FIG. 11 is an equivalent circuit of the linear circuit. As illustrated in FIG. 11, in a linear circuit 10c, resistor R is electrically connected between ports P1 and P2. Ports P1 and P2 are terminated with a reference impedance Z0 (e.g., 50Ω).

At direct current (that is, when the frequency is 0 Hz), S21 in the matrix of the S-parameter of linear circuit 10c is considered. Since resistor R has almost no reactance components, S21 is almost a real number. Thus, the description will be provided considering S21 as the real number part of S21. When the resistance value of resistor R is denoted as R and the impedance (resistance value because of a real number) of the reference impedance is denoted as Z0, S21 is equal to 2× Z0/(R+2× Z0).

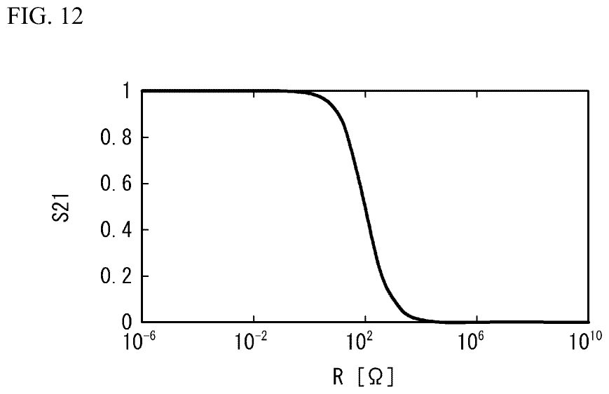

Here, Z0 is set to 50Ω. FIG. 12 is a diagram illustrating S21 with respect to a resistance value R of resistor R. As illustrated in FIG. 12, at a resistance value R of 100Ω, S21 is 0.5. At a resistance value R of 1Ω or less, S21 is approximately one. At a resistance value R of 10000Ω or more, S21 is approximately zero. For a small resistance value R, ports P1 and P2 are short-circuited, and for a large resistance value R, ports P1 and P2 are opened.

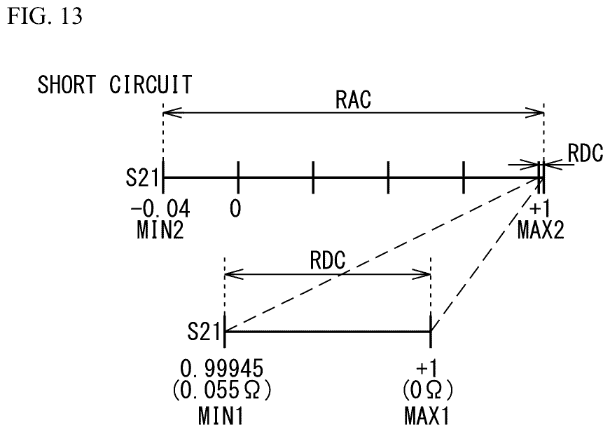

FIG. 13 is a diagram illustrating S21 when ports P1 and P2 are short-circuited at direct current. In FIG. 13, the horizontal direction represents S21. The lower part is an enlarged view of the range of S21 near +1 in the upper part. When the ports are short-circuited at direct current, a range RDC that S21 can take is close to +1, for example, from +0.99945 to +1. This corresponds to a resistance value R of 0.055Ω to 0Ω. On the other hand, at alternating current, S21 can take a range RAC from −0.04 to +1. For example, ports P1 and P2 of Example 1 are short-circuited at direct current. However, this is because the impedance of inductor L1 is j (2πf) L1 (j is an imaginary unit) at an alternating current of frequency f.

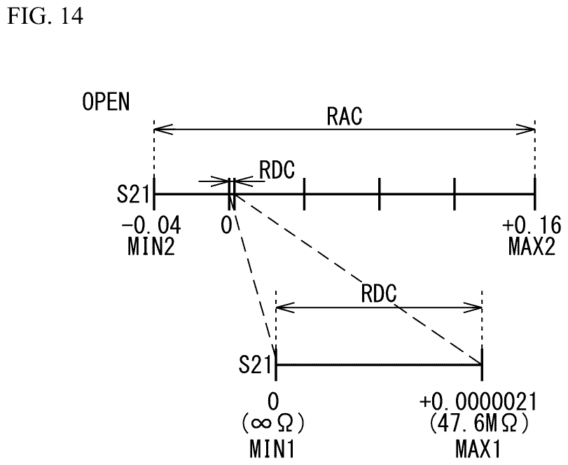

FIG. 14 is a diagram illustrating S21 when ports P1 and P2 are opened at direct current. In FIG. 14, the horizontal direction represents S21. The lower part is an enlarged view of the range of S21 near zero in the upper part. When the ports are opened at direct current, range RDC that S21 can take is close to zero, for example, from 0 to +0.0000021. This corresponds to a resistance value from infinitely large Ω to 47.6 MΩ. On the other hand, at alternating current, S21 can take range RAC from −0.04 to +0.16. For example, ports P1 and P2 in Example 2 are opened at direct current. However, this is because the impedance of capacitor Cis-1/j (2πf) C (j is an imaginary unit) at an alternating current with frequency f.

In the first comparative example, the same learned model is used regardless of direct current and alternating current. For example, for opened circuit at direct current, range RAC is used for normalization. In this case, maximum value MAX2 and minimum value MIN2 are used.

When the resistance value R between ports P1 and P2 at direct current is 100 MΩ, the real number part of S21 is 1×10⁻⁶. Normalizing S21 under the condition of MAX2=0.16 and MIN2=−0.04, NS21 is determined to be (1×10⁻⁶−(−0.04))/(0.16+ (−0.04))=0.200005. The learned model is generated based on NS21 described above.

If NS21 has an error of 0.001 relative to 0.200005 when NS21 is estimated using the learned model at step S14 in FIG. 10, S21 is determined to be 0.201005× (0.16−(−0.04))+ (−0.04)=0.000201 in the decoding step of step S16. This value of S21 corresponds to 500 kΩ, and resistance value R becomes 1/200 of 100 MΩ due to an error of 0.0001.

As illustrated in FIG. 12, for short or opened circuit at direct current, S21 hardly changes even when resistance value R changes. Thus, when S21 is estimated by normalizing and decoding at alternating current and direct current, the error of resistance value R becomes large for direct current.

### First Embodiment

Thus, in the first embodiment, when the ports are opened at direct current, restriction unit 26 restricts S-parameter S for which the frequency is 0 Hz to be within range RDC. S-parameter S is restricted to be a value within a range from a minimum value MIN1 to a maximum value MAX1 of range RDC.

For example, in step S14 of FIG. 9, a case in which estimated S-parameter S21 includes an error and S21 is 0.000201 is considered. As in FIG. 14, MAX1 is 0.0000021 and MIN1 is zero. Thus, S21 is determined to be MAX (0, MIN (0.0000021, 0.000201))=0.0000021. This value of S21 corresponds to 47.6 MΩ. Thus, S21 is restricted within range RDC, and resistance value R is half of 100 MΩ even when there is the error.

According to the first embodiment, as illustrated in FIG. 9, in steps S14 and S16, estimation unit 24 estimates S-parameter S at frequency f from information A and frequency f based on learned model M. As in steps S18 and S22, when frequency f is 0 Hz and estimated S-parameter S is outside range RDC, restriction unit 26 restricts S-parameter S to be within range RDC. This can improve the accuracy of the estimation of S-parameter S even when the error of S-parameter S at direct current is large. The S-parameters to be estimated are S-parameters for two ports among the plurality of ports P1 to Pn in FIG. 1.

For all elements in the matrix of the S-parameter, the S-parameter may be estimated. For some elements in the matrix of the S-parameter, the S-parameter does not have to be estimated.

The S-parameter for alternating current can be estimated with high accuracy. Thus, as in step S18 of FIG. 9, restriction unit 26 does not restrict estimated S-parameter S when the frequency is other than 0 Hz. Thus, when the frequency is other than 0 Hz, the processing of processor 32 can be simplified.

In step S22, restriction unit 26 sets S-parameter S to maximum value MAX1 (first maximum value) of range RDC when estimated S-parameter S is larger than maximum value MAX1, and sets S-parameter S to minimum value MIN1 (first minimum value) of range RDC when estimated S-parameter S is smaller than minimum value MIN1. This can further improve the accuracy of the estimation of S-parameter S.

The S-parameter in training data T (i, 0) is normalized by maximum value MAX2 (second maximum value) and minimum value MIN2 (second minimum value). Maximum value MAX2 is larger than maximum value MAX1 of range RDC, and minimum value MIN2 is smaller than minimum value MIN1 of range RDC. As illustrated in FIGS. 13 and 14, when range RAC is wider than range RDC, the error of estimated S-parameter S becomes large for direct current. Thus, restriction unit 26 restricts S-parameter S, and thus it is possible to further improve the accuracy of the estimation of S-parameter S. Range RDC is, for example, 1/10 or less of range RAC, and is 1/100 or less of range RAC.

Estimation unit 24 estimates the S-parameter by decoding the value generated based on learned model M based on maximum value MAX2 and minimum value MIN2. Thus, even when the maximum value and the minimum value of the S-parameter for direct current are significantly different from the maximum value and the minimum value of the S-parameter for alternating current, the S-parameter can be estimated with high accuracy.

Restriction unit 26 restricts S-parameter S to be within range RDC when the two ports are opened or short-circuited, and restriction unit 26 does not restrict S-parameter S when the two ports are not opened or short-circuited. When the two ports are opened or short-circuited, the accuracy of the estimation of the S-parameter is lowered when the method in the first comparative example is used. Thus, by estimating the S-parameter using the method in the first embodiment, the accuracy of the estimation of the S-parameter can be improved. When two ports are not opened or short-circuited, restriction unit 26 does not restrict S-parameter S, and thus the accuracy of the estimation of S-parameter S can be improved.

When the S-parameter is S21, the accuracy of the estimation of the S-parameter is lowered by using the method in the first comparative example as described with reference to FIGS. 13 and 14. Thus, by estimating the S-parameter using the method in the first embodiment, the accuracy of the estimation of the S-parameter can be improved. In linear circuit 10, S21 and S12 are equivalent to each other.

Each process (each function) of the above-described embodiments is implemented by a circuitry including one or more processors. The circuitry may be configured by an integrated circuit or the like in which one or more memories, various analog circuits, and various digital circuits are combined in addition to the one or more processors. The one or more memories store a program (command) for causing the one or more processors to execute the processes. The one or more processors may execute the processes in accordance with the program read from the one or more memories, or may execute the processes in accordance with a logic circuit designed in advance to execute the processes.

The processor may be any of various processors suitable for control of a computer, such as a CPU, a graphics processing unit (GPU), a digital signal processor (DSP), a field programmable gate array (FPGA), and an application specification integrated circuit (ASIC). The plurality of processors physically separated from each other may execute the processes in cooperation with each other. For example, the processors mounted on a plurality of physically separated computers may execute the processes in cooperation with each other via a network such as a local area network (LAN), a wide area network (WAN), or the Internet.

The program may be installed in the memory from an external server device or the like via the network, or may be distributed in a state of being stored in a recording medium such as a CD-ROM, a DVD-ROM, or a semiconductor memory and installed in the memory from the recording medium.

The embodiments disclosed herein are to be considered as illustrative and non-restrictive in all respects. The scope of the present disclosure is defined by the claims, not in the sense described above, and is intended to include all modifications within the scope and meaning equivalent to the scope of the claims.

1. A non-transitory computer-readable recording medium having stored therein a program for causing a computer to execute a process, the process comprising:
acquiring first information related to a linear circuit having a plurality of ports for receiving or outputting a high frequency signal, and second information related to a frequency of the high frequency signal;
estimating an S-parameter for two ports of the plurality of ports at the frequency, based on a learned model from the first information and the second information; and
when the second information indicates that the frequency is 0 Hz and the estimated S-parameter is out of a range, restricting the S-parameter to be within the range, wherein
the learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies.

2. The non-transitory computer-readable recording medium according to claim 1,
wherein the restricting never restricts the estimated S-parameter when the second information indicates that the frequency is other than 0 Hz.

3. The non-transitory computer-readable recording medium according to claim 1, wherein
when the estimated S-parameter is larger than a first maximum value of the range, the restricting sets the S-parameter to the first maximum value, and
when the estimated S-parameter is smaller than a first minimum value of the range, the restricting sets the S-parameter to the first minimum value.

4. The non-transitory computer-readable recording medium according to claim 1, wherein
each of the plurality of S-parameters in the plurality of pieces of training data is normalized by a second maximum value and a second minimum value,
the second maximum value is larger than a maximum value of the range, and
the second minimum value is smaller than a minimum value of the range.

5. The non-transitory computer-readable recording medium according to claim 4, wherein the estimating estimates the S-parameter by decoding, based on the second maximum value and the second minimum value, a value generated based on the learned model.

6. The non-transitory computer-readable recording medium according to claim 1, wherein
the restricting restricts the S-parameter to be within the range when the two ports are opened or short-circuited, and
the restricting never restricts the S-parameter when the two ports are not opened or short-circuited.

7. The non-transitory computer-readable recording medium according to claim 6, wherein when the two ports are port 1 and port 2, the S-parameter is S21.

8. An estimation method comprising:
acquiring first information related to a linear circuit having a plurality of ports for receiving or outputting a high frequency signal, and second information related to a frequency of the high frequency signal;
estimating an S-parameter for two ports of the plurality of ports at the frequency, based on a learned model from the first information and the second information; and
when the second information indicates that the frequency is 0 Hz and the estimated S-parameter is out of a range, restricting the S-parameter to be within the range, wherein
the learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies.

9. An estimation device comprising:
an acquirer that acquires first information related to a linear circuit having a plurality of ports for receiving or outputting a high frequency signal, and second information related to a frequency of the high frequency signal;
an estimator that estimates an S-parameter for two ports of the plurality of ports at the frequency, based on a learned model from the first information and the second information; and
a restrictor that, when the second information indicates that the frequency is 0 Hz and the estimated S-parameter is out of a range, restricts the S-parameter to be within the range, wherein
the learned model is generated by performing machine learning on a plurality of pieces of training data, the plurality of pieces of training data defining a relationship among a plurality of pieces of first information of the linear circuit, a plurality of frequencies, and a plurality of S-parameters calculated for a corresponding one of the plurality of pieces of first information and a corresponding one of the plurality of frequencies.
